(19) United States
(12) Patent Application Publication
(10) Pub. No.: US 2026/0088709 A1
(43) Pub. Date: Mar. 26, 2026

(54) POWER SUPPLY DEVICE, POWER SUPPLY CONTROL DEVICE AND CONTROL METHOD THEREOF

(71) Applicant: Delta Electronics (Thailand) Public Company Limited, Samutprakarn (TH)

(72) Inventors: Bing Fan, Shanghai (CN); Yi Zhu, Shanghai (CN); Youzhun Cai, Shanghai (CN); Kai Dong, Shanghai (CN)

(21) Appl. No.: 19/332,468

(22) Filed: Sep. 18, 2025

(30) Foreign Application Priority Data
Sep. 20, 2024 (CN) 202411322826.X
Dec. 31, 2024 (CN) 202411999063.2

(51) Int. Cl. H02M 1/34; H02J 3/00; H02M 7/217

(52) U.S. Cl. CPC H02M 1/34; H02J 3/007; H02M 7/217; H02J 3/001

(57) ABSTRACT

A power supply device, a power supply control device and a control method thereof are provided. The power supply control device is electrically connected to a power source configured to provide power to a post-stage circuit of the power supply control device, and the power supply control device includes a current limiting module and a control unit. The current limiting module is electrically connected to the power source and the post-stage circuit and includes first and second current limiting units electrically connected in parallel. The first current limiting unit is configured to limit an inrush current generated during startup of the post-stage circuit, and the second current limiting unit is configured to limit an inrush current generated during a fluctuation of the power source. The control unit is electrically connected to the current limiting module and is configured to control the first and second current limiting units.

### CROSS-REFERENCE TO RELATED APPLICATION

This application claims priority to China Patent Application No. 202411322826.X, filed on Sep. 20, 2024, and China Patent Application No. 202411999063.2, filed on Dec. 31, 2024, the entire contents of which are incorporated herein by reference for all purposes.

### FIELD OF THE INVENTION

The present disclosure relates to a power supply device, a power supply control device and a control method thereof, and more particularly to a power supply device, a power supply control device and a control method thereof which can realize soft starting and current limiting.

### BACKGROUND OF THE INVENTION

In a centralized power supply architecture, compared to a single-input power source or redundant structure, a power source equipped with an automatic ATS (auto transfer switch) function can significantly reduce the cost and volume of power source and simultaneously enhance the reliability of supplying power. In high-power power supply products such as switching power supplies, large electrolytic capacitors are commonly used. When the starting power is turned on or when the input power is interrupted and then restored (i.e., ride-through), the current which charges the post-stage electrolytic capacitor is large, resulting in a large peak current.

During the switching process between multiple input power sources, an inrush current which charges the post-stage electrolytic capacitor would be generated. The conventional method of suppressing the inrush current is to connect a thermistor (i.e., a current limiting resistor) in series within the circuit loop to limit the inrush current generated during the switching process. However, due to the high transient power of the current limiting resistor (specifically depending on the capacitance of the electrolytic capacitor and the output power of the power supply device), a sufficiently large size is required for heat dissipation. As a result, large space within the power supply device needs to be used for heat dissipation. Additionally, the current limiting resistor may also be easily affected by temperature.

Therefore, there is a need of providing a power supply device, a power supply control device and a control method thereof in order to overcome the drawbacks of the conventional technologies.

### SUMMARY OF THE INVENTION

The present disclosure provides a power supply device, a power supply control device and a control method thereof which can limit the inrush current generated during startup to realize soft start. Further, the power supply device, the power supply control device and the control method thereof of the present disclosure also can limit the inrush current generated during the fluctuation of the received power source.

In accordance with an aspect of the present disclosure, a power supply control device is provided. The power supply control device is electrically connected to a power source configured to provide power to a post-stage circuit of the power supply control device, and the power supply control device includes a current limiting module and a control unit. The current limiting module is electrically connected to the power source and the post-stage circuit and includes a first current limiting unit and a second current limiting unit electrically connected in parallel. The first current limiting unit is configured to limit an inrush current generated during startup of the post-stage circuit, and the second current limiting unit is configured to limit an inrush current generated during a fluctuation of the power source. The control unit is electrically connected to the current limiting module and is configured to control the first current limiting unit and the second current limiting unit.

In accordance with another aspect of the present disclosure, a control method of a power supply control device is provided. The power supply control device is electrically connected to a power source configured to provide power to a post-stage circuit of the power supply control device. The power supply control device includes a current limiting module electrically connected to the power source and the post-stage circuit. The current limiting module includes a first current limiting unit and a second current limiting unit electrically connected in parallel. The control method includes: controlling the first current limiting unit to limit an inrush current generated during startup of the post-stage circuit; and controlling the second current limiting unit to limit an inrush current generated during a fluctuation of the power source.

In accordance with an aspect of the present disclosure, a power supply device is provided. The power supply device is electrically connected to a power source and includes a post-stage circuit, a current limiting module and a control unit. The post-stage circuit includes a power factor correction circuit and a capacitor electrically connected in parallel, and the post-stage circuit is powered by the power source. The current limiting module is electrically connected between the power source and the post-stage circuit or between the power factor correction circuit and the capacitor, and includes a first current limiting unit and a second current limiting unit electrically connected in parallel. The first current limiting unit is configured to limit an inrush current generated during startup of the post-stage circuit, and the second current limiting unit is configured to limit an inrush current generated during a fluctuation of the power source. The control unit is electrically connected to the current limiting module and is configured to control the first current limiting unit and the second current limiting unit.

### BRIEF DESCRIPTION OF THE DRAWINGS

FIG. 1 is a schematic block diagram illustrating a power supply control device according to an embodiment of the present disclosure;

FIG. 2 is a schematic circuit diagram illustrating the power supply control device according to an embodiment of the present disclosure;

FIG. 3 is a schematic oscillogram illustrating the startup of the post-stage circuit of the power supply control device of FIG. 2 when the first power source is normal;

FIG. 4 is a schematic oscillogram illustrating the startup of the post-stage circuit of the power supply control device of FIG. 2 when the first power source fails and the second power source is normal;

FIG. 5 is a schematic oscillogram illustrating the power supply control device of FIG. 2 switching from the first power source to the second power source during operation due to the failure of the first power source;

FIG. 6 is a schematic oscillogram illustrating a situation that during operation, the power supply control device of FIG. 2 switches from the first power source to the second power source due to the failure of first power source and then switches back to the first power source as the first power source recovers;

FIG. 7 is a schematic circuit diagram illustrating a power supply control device according to another embodiment of the present disclosure;

FIG. 8 is a schematic oscillogram illustrating the startup of the post-stage circuit of the power supply control device of FIG. 7 when the first power source is normal;

FIG. 9 is a schematic oscillogram illustrating the power supply control device of FIG. 7 switching from the first power source to the second power source during operation due to the failure of the first power source;

FIG. 10 is a schematic oscillogram illustrating a situation that during operation, the power supply control device of FIG. 7 switches from the first power source to the second power source due to the failure of first power source and then switches back to the first power source as the first power source recovers;

FIG. 11 is a schematic circuit diagram illustrating a power supply control device according to another embodiment of the present disclosure;

FIG. 12 is a schematic circuit diagram illustrating a power supply device according to an embodiment of the present disclosure;

FIG. 13 is a schematic circuit diagram illustrating a power supply device according to another embodiment of the present disclosure;

FIG. 14 is a schematic circuit diagram illustrating a power supply device according to further another embodiment of the present disclosure;

FIG. 15 is a schematic circuit diagram illustrating a variant of the power supply device of FIG. 14; and

FIG. 16 is a schematic oscillogram illustrating the operation of the power supply device of FIG. 15 when the power source recovers shortly after a brief failure.

### DETAILED DESCRIPTION

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

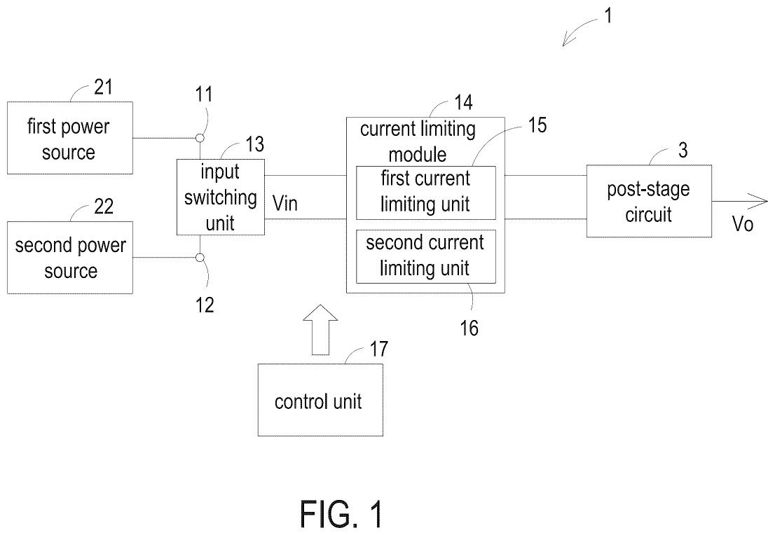

Please refer to FIG. 1. FIG. 1 is a schematic block diagram illustrating a power supply control device according to an embodiment of the present disclosure. As shown in FIG. 1, the power supply control device 1 includes a first input terminal 11, a second input terminal 12, an input switching unit 13, a current limiting module 14, and a control unit 17. The first input terminal 11 is electrically connected to a first power source 21, and the second input terminal 12 is electrically connected to a second power source 22. The input switching unit 13 is configured to switch between connecting to the first input terminal 11 and connecting to the second input terminal 12 so that one of the first power source 21 and the second power source 22 serves as a supply power source which supplies power to a post-stage circuit 3. The current limiting module 14 is electrically connected to the input switching unit 13 and the post-stage circuit 3. The current limiting module 14 includes a first current limiting unit 15 and a second current limiting unit 16 electrically connected in parallel. The first current limiting unit 15 is configured to limit an inrush current generated during startup of the post-stage circuit 3, and the second current limiting unit 16 is configured to limit an inrush current generated during switching of the input switching unit 13. The control unit 17 is electrically connected to the input switching unit 13 and the current limiting module 14. The control unit 17 is configured to control the input switching unit 13, the first current limiting unit 15 and the second current limiting unit 16. The control method of the power supply control device 1 is detailed below.

Before the post-stage circuit 3 of the power supply control device 1 starts up, both the first current limiting unit 15 and the second current limiting unit 16 are off. When the post-stage circuit 3 of the power supply control device 1 starts up, the first current limiting unit 15 is controlled to turn on to limit the magnitude of the current flowing through the first current limiting unit 15, and an output voltage Vo of the post-stage circuit 3 gradually increases. When a difference between a maximum value of an input voltage Vin and the output voltage Vo is less than a first threshold value (for example but not limited to 20 V), the control unit 17 controls the second current limiting unit 16 to turn on. The first threshold value is set to prevent the current flowing through the second current limiting unit 16 from being too large. Thereby, soft start function is realized. Moreover, after the second current limiting unit 16 is turned on, the control unit 17 may either keep the first current limiting unit 15 on or control the first current limiting unit 15 to turn off.

When the second current limiting unit 16 turns on and normally supplies power to the post-stage circuit 3, the control unit 17 is configured to turn off both the first current limiting unit 15 and the second current limiting unit 16 if the supply power source (the first power source 21 or the second power source 22) fails. After the first current limiting unit 15 and the second current limiting unit 16 are turned off, the input switching unit 13 is allowed to switch. It is noted that during switching of the input switching unit 13, the first input terminal 11 and the second input terminal 12 of the power supply control device 1 have to be completely disconnected from the post-stage circuit 3. When switching to another power source (i.e., the input switching unit 13 switches it connection from one of the first input terminal 11 and second input terminal 12 to the other), the control unit 17 controls the second current limiting unit 16 to operate in a current limiting state or a fully conductive state according to a difference between an absolute value of an input voltage Vin received by the power supply control device 1 and an output voltage Vo of the post-stage circuit 3. In particular, if the difference between the absolute value of the input voltage Vin and the output voltage Vo is greater than a second threshold value, the control unit 17 controls the second current limiting unit 16 to be in the current limiting state to limit the current flowing through the second current limiting unit 16 to a preset current, thereby preventing surge current. Conversely, if the difference between the absolute value of the input voltage Vin and the output voltage Vo is less than or equal to the second threshold value, which means that the input voltage Vin and the output voltage Vo are close, the control unit 17 controls the second current limiting unit 16 to be in the fully conductive state. It should be understood that the second threshold value may be equal or unequal to the first threshold value.

In an embodiment, the input switching unit 13 is connected to one of the first input terminal 11 and the second input terminal 12 by default. For instance, the input switching unit 13 may be connected to the first input terminal 11 by default, and the first power source 21 is used as the supply power source by default. Specifically, the input switching unit 13 includes an input relay. When the first power source 21 is normal, the input relay remains connected to the first input terminal 11 without additional control. If the first power source 21 fails, the input relay switches to connect to the second input terminal 12. Further, once the first power source 21 recovers, the input relay switches back to connect to the first input terminal 11.

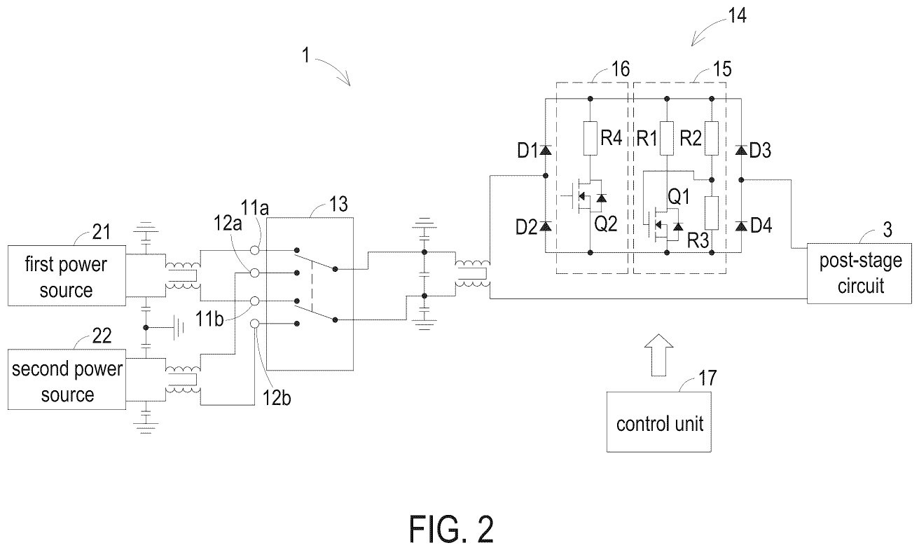

Please refer to FIG. 2. FIG. 2 is a schematic circuit diagram illustrating the power supply control device 1 according to an embodiment of the present disclosure. In FIG. 2, the component parts and elements corresponding to those of FIG. 1 are designated by identical numeral references, and detailed descriptions thereof are omitted herein. In this embodiment, as shown in FIG. 2, the first input terminal 11 includes a first positive input terminal 11a and a first negative input terminal 11b which are electrically connected to the positive and negative terminals of the first power source 21 respectively. The second input terminal 12 includes a second positive input terminal 12a and a second negative input terminal 12b which are electrically connected to the positive and negative terminals of the second power source 22 respectively. The input relay of the input switching unit 13 may be a double-pole double-throw switch as illustrated in the figure, but not limited thereto. The first current limiting unit 15 includes a current limiting resistor R1 and a first transistor Q1 electrically connected in series between a first node and a second node. The first transistor Q1 is configured to be turned on based on the difference between the input voltage Vin received by the power supply control device 1 and the output voltage Vo of the post-stage circuit 3 when the post-stage circuit 3 starts up, thereby allowing the current flowing into the post-stage circuit 3 to be limited by the current limiting resistor R1. In this embodiment, the input current received by the power supply control device 1 is transmitted to the post-stage circuit 3 through the current limiting resistor R1 and the first transistor Q1. In an embodiment, the first current limiting unit 15 further includes a first divider resistor R2 and a second divider resistor R3. The first and second terminals of the first divider resistor R2 are electrically connected to the first node and a control terminal of the first transistor Q1 respectively. The first and second terminals of the second divider resistor R3 are electrically connected to the control terminal of the first transistor Q1 and the second node respectively. At the moment that the post-stage circuit 3 starts up, the output voltage Vo is zero, and there is a large voltage difference between the input voltage Vin and the output voltage Vo, which causes a voltage drop across the second divider resistor R3 sufficient to turn on the first transistor Q1. Therefore, the use of the first divider resistor R2 and the second divider resistor R3 eliminates the need for a separate supply power source to drive the first transistor Q1. Of course, in some embodiments, the first divider resistor R2 and the second divider resistor R3 may not be disposed.

The second current limiting unit 16 includes a sampling resistor R4 and a second transistor Q2 electrically connected in series, and the sampling resistor R4 and the second transistor Q2 are respectively connected to the first and second nodes. The control unit 17 can selectively control the second transistor Q2 to operate in a linear region or a saturation region so that the second current limiting unit 16 operates in the current limiting state or the fully conductive state correspondingly. Moreover, the control unit 17 may generate a drive signal for controlling the second transistor Q2 according to the current flowing through the sampling resistor R4. In addition, the first transistor Q1 and the second transistor Q2 are not limited to the implementations shown in the figure and are for example but not limited to metal-oxide-semiconductor field-effect transistors or insulated gate bipolar transistors.

In an embodiment, the power supply control device 1 further includes a rectifier circuit configured to rectify the current flowing into the first current limiting unit 15 and the second current limiting unit 16 into DC current. The rectifier circuit includes a first rectifier bridge arm and a second rectifier bridge arm electrically connected in parallel to the first current limiting unit 15 and the second current limiting unit 16. The first rectifier bridge arm includes a first diode D1 and a second diode D2, and a common connection point of the first diode D1 and the second diode D2 is connected to the input switching unit 13. The second rectifier bridge arm includes a third diode D3 and a fourth diode D4, and a common connection point of the third diode D3 and the fourth diode D4 is connected to the post-stage circuit 3.

Based on the circuit topology shown in FIG. 2 and taking an example that the input switching unit 13 is connected to the first input terminal 11 by default and the first power source 21 serves as supply power source by default, the operation of the power supply control device 1 is described in detail as follows.

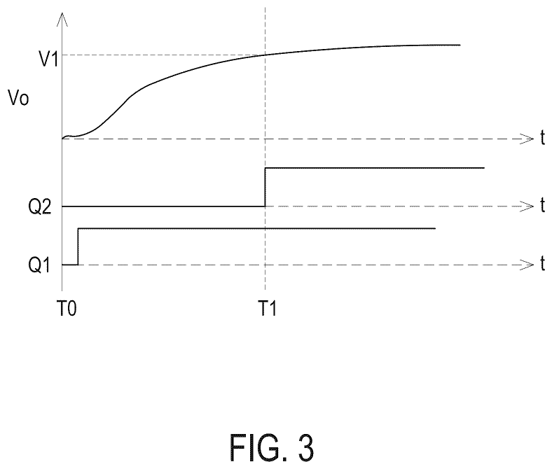

FIG. 3 is a schematic oscillogram illustrating the startup of the post-stage circuit 3 of the power supply control device 1 when the first power source 21 is normal. In FIG. 3, the horizontal axis represents time t. Please refer to FIG. 3 in conjunction with FIG. 2. At time T0, the power supply control device 1 receives the input voltage Vin, both the first transistor Q1 and the second transistor Q2 are in the off state, and the output voltage Vo has not yet been established. Afterwards, the first transistor Q1 is automatically turned on by the difference between the input voltage Vin and the output voltage Vo. Particularly, as the difference between the input voltage Vin and the output voltage Vo is large, the first divider resistor R2 and the second divider resistor R3 divide voltage to establish a voltage at the control terminal of the first transistor Q1, thereby generating a drive signal to turn the first transistor Q1 on. Once the first transistor Q1 is turned on, the input current received by the power supply control device 1 flows through the first current limiting unit 15 to the post-stage circuit 3, where the first current limiting unit 15 limits the magnitude of the current therethrough to allow the output voltage Vo to increase gradually. At time T1, the output voltage Vo reaches a preset voltage V1. At this time, the difference between the maximum value of input voltage Vin and the output voltage Vo is less than the first threshold value, and thus the second transistor Q2 is turned on. In this embodiment, after the second transistor Q2 is turned on (i.e., after time T1), the first transistor Q1 remains on and waits for the subsequent turn-off instruction, and the first transistor Q1 is turned off at the latest before the input switching unit 13 switches. Of course, the first transistor Q1 may be turned off after a delay once the second transistor Q2 is turned on.

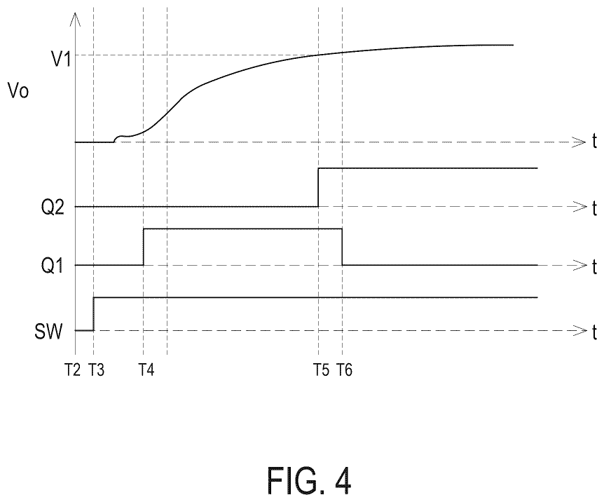

FIG. 4 is a schematic oscillogram illustrating the startup of the post-stage circuit 3 when the first power source 21 fails and the second power source 22 is normal. In FIG. 4, SW reflects the switching state of the input switching unit 13, SW at low level represents that the input switching unit 13 is connected to the first input terminal 11, and SW at high level represents that the input switching unit 13 is connected to the second input terminal 12. Please refer to FIG. 4 in conjunction with FIG. 2. At time T2, the power supply control device 1 receives the input voltage Vin, and both the first transistor Q1 and the second transistor Q2 are in the off state. At time T3, since the first power source 21 fails and is unable to supply power normally, the input switching unit 13 switches from connecting to the first input terminal 11 to connecting to the second input terminal 12. At time T4, the first transistor Q1 is automatically turned on by the difference between the input voltage Vin and the output voltage Vo. Once the first transistor Q1 is turned on, the input current received by the power supply control device 1 flows through the first current limiting unit 15 to the post-stage circuit 3, where the first current limiting unit 15 limits the magnitude of the current therethrough to allow the output voltage Vo to increase gradually. At time T5, the output voltage Vo reaches the preset voltage V1. At this time, the difference between the maximum value of input voltage Vin and the output voltage Vo is less than the first threshold value, and thus the second transistor Q2 is turned on. In this embodiment, after the second transistor Q2 is turned on, at time T6, the first transistor Q1 is turned off. In another embodiment, the first transistor Q1 may remain in the on state after time T5 and waits for the subsequent turn-off instruction.

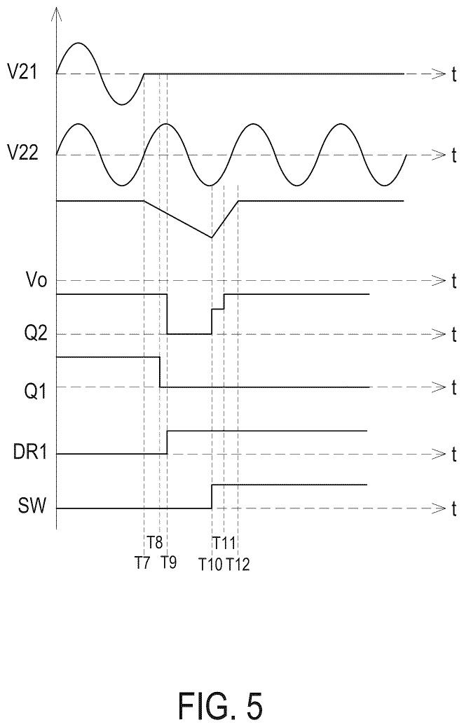

FIG. 5 is a schematic oscillogram illustrating the power supply control device 1 switching from the first power source 21 to the second power source 22 during operation due to the failure of the first power source 21. In FIG. 5, V21 represents the power provided by the first power source 21, V22 represents the power provided by the second power source 22, and DR1 represents the control signal of the input switching unit 13. Please refer to FIG. 5 in conjunction with FIG. 2. Before time T7, the input switching unit 13 is connected to the first input terminal 11. At time T7, the first power source 21 fails and stops providing power, and the output voltage Vo begins to decrease. After a certain delay (to avoid false operation), at time T8, the control unit 17 controls the first transistor Q1 to turn off. It should be understood that turning off the first transistor Q1 at time T8 is just an example, and actually the first transistor Q1 only needs to turn off before time T9 (i.e., before the control unit 17 controls the input switching unit 13 to switch). At time T9, the control unit 17 controls the second transistor Q2 to turn off and outputs the control signal DR1 for controlling the input switching unit 13 to switch to connect to the second input terminal 12. After a period of delay, at time T10, the input switching unit 13 switches to connect to the second input terminal 12, and the second power source 22 begins to serve as the supply power source. At this time, the control unit 17 controls the second transistor Q2 to turn on, thereby allowing the output voltage Vo to increase. The control for the second transistor Q2 depends on a difference between an absolute value of the input voltage Vin and the output voltage Vo such that the inrush current caused by the switching of the input switching unit 13 is limited. In specific, at time T10, the difference between the absolute value of the input voltage Vin and the output voltage Vo is greater than the second threshold value, thus the control unit 17 controls the second transistor Q2 to operate in the linear region and regulates the drive voltage of the second transistor Q2 to limit the current flowing through the second transistor Q2 to the preset current. Under this circumstance, the second current limiting unit 16 is in the current limiting state. The second threshold value is for example but not limited to zero. At time T11, the difference between the absolute value of the input voltage Vin and the output voltage Vo begins to be less than or equal to the second threshold value, thus the control unit 17 controls the second transistor Q2 to operate in the saturation region, which means the second current limiting unit 16 is in the fully conductive state. After the second transistor Q2 operates in the saturation region, at time T12, the output voltage Vo reaches a reference value which refers to the output voltage Vo when the post-stage circuit 3 is in normal operation.

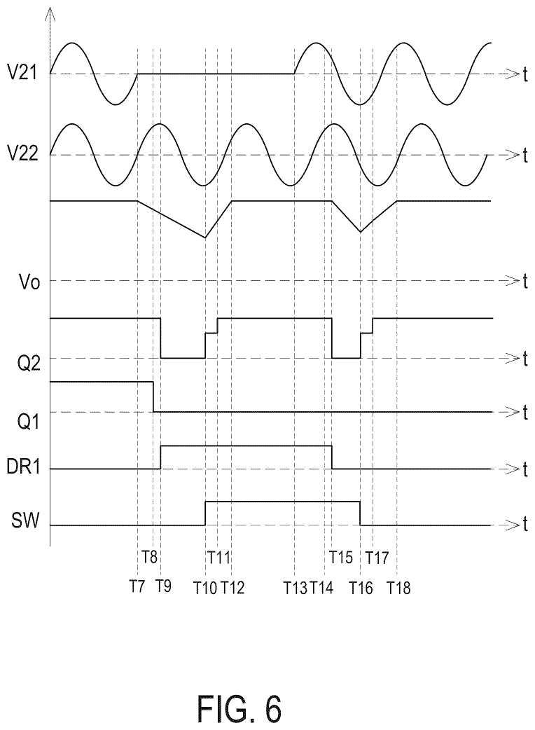

FIG. 6 is a schematic oscillogram illustrating a situation that during operation, the power supply control device 1 switches from the first power source 21 to the second power source 22 due to the failure of first power source 21 and then switches back to the first power source 21 as the first power source 21 recovers. In FIG. 6, the waveforms and operations before time T13 are similar with that shown in FIG. 5, and thus the detailed descriptions thereof are omitted herein. Please refer to FIG. 6 in conjunction with FIG. 2. After the power supply control device 1 switches to use the second power source 22 as the supply power source due to the failure of the first power source 21, at time T13, the first power source 21 recovers. In a certain period of time, the voltage of the first power source 21 is detected. After confirming that the first power source 21 is normal, at time T15, the control unit 17 controls the second transistor Q2 to turn off and outputs the control signal DR1 for controlling the input switching unit 13 to switch to connect to the first input terminal 11. After a delay, at time T16, the input switching unit 13 switches to connect to the first input terminal 11, and the first power source 21 begins to serve as the supply power source. At this time, the control unit 17 controls the second transistor Q2 to turn on, thereby allowing the output voltage Vo to increase. The control for the second transistor Q2 depends on the difference between the absolute value of the input voltage Vin and the output voltage Vo such that the inrush current caused by the switching of the input switching unit 13 is limited. In specific, at time T16, the difference between the absolute value of the input voltage Vin and the output voltage Vo is greater than the second threshold value, thus the control unit 17 controls the second transistor Q2 to operate in the linear region and regulates the drive voltage of the second transistor Q2 to limit the current flowing through the second transistor Q2 to the preset current. Under this circumstance, the second current limiting unit 16 is in the current limiting state. At time T17, the difference between the absolute value of the input voltage Vin and the output voltage Vo begins to be less than or equal to the second threshold value, thus the control unit 17 controls the second transistor Q2 to operate in the saturation region, which means the second current limiting unit 16 is in the fully conductive state. After the second transistor Q2 operates in the saturation region, at time T18, the output voltage Vo reaches the reference value.

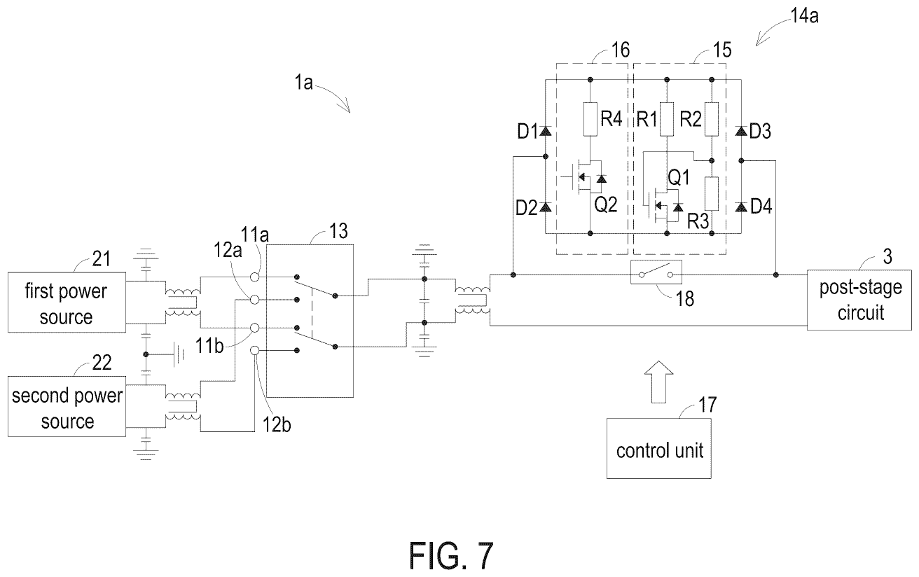

In addition, in an embodiment, as shown in FIG. 7, the current limiting module 14a of the power supply control device 1a further includes a main relay 18 electrically connected in parallel to the first current limiting unit 15 and the second current limiting unit 16. The effect of the main relay 18 on the operation of the power supply control device 1a is explained as follows.

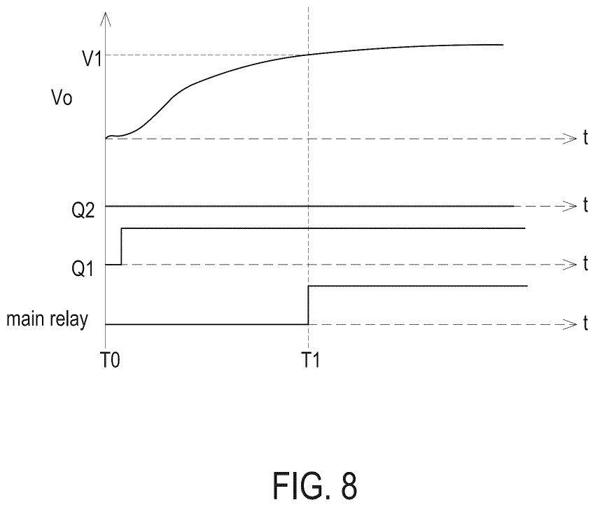

Under the circumstance that the post-stage circuit 3 of the power supply control device 1a starts up with the first power source 21 operating normally, the corresponding operating waveforms are schematically shown in FIG. 8. The input current received by the power supply control device 1a flows through the first current limiting unit 15 to the post-stage circuit 3, which allows to the output voltage Vo to increase gradually. Afterwards, at time T1, the output voltage Vo reaches the preset voltage V1, and correspondingly the difference between the maximum value of input voltage Vin and the output voltage Vo is less than the first threshold value. At this time, the main relay 18 is turned on, while the second transistor Q2 remains in the off state.

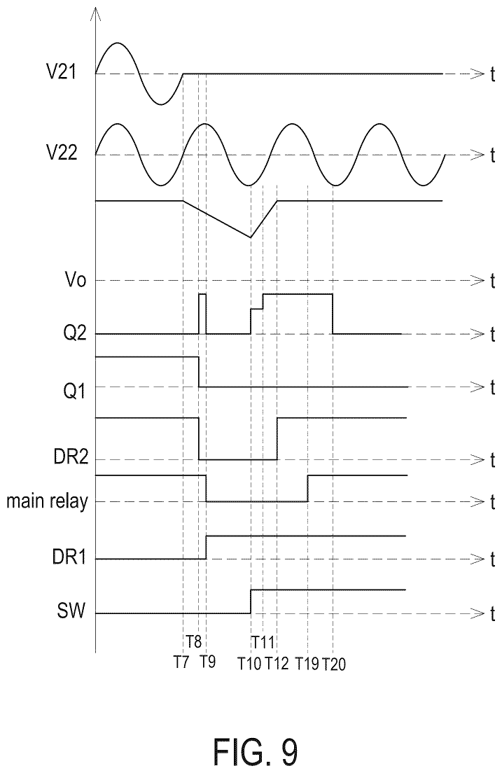

Under the circumstance that the power supply control device 1a switches from the first power source 21 to the second power source 22 during operation due to the failure of the first power source 21, the corresponding operating waveforms are schematically shown in FIG. 9. In FIG. 9, DR2 represents the control signal of the main relay 18. After the first power source 21 fails and stops providing power, at time T8, the control unit 17 outputs the control signal DR2 for controlling the main relay 18 to turn off, and the control unit 17 also controls the first transistor Q1 to turn off. Moreover, to avoid arcing while turning off the main relay 18, the control unit 17 further controls the second transistor Q2 to be in the fully conductive state. After a delay, at time T9, the main relay 18 turns off, and the control unit 17 controls the second transistor Q2 to turn off and outputs the control signal DR1 for controlling the input switching unit 13 to switch to connect to the second input terminal 12. Then, at time T12, the output voltage Vo reaches the reference value, and the control unit 17 outputs the control signal DR2 for controlling the main relay 18 to turn on. Afterwards, at time T19, the main relay 18 turns on. Then, at time T20, the control unit 17 controls the second transistor Q2 to turn off.

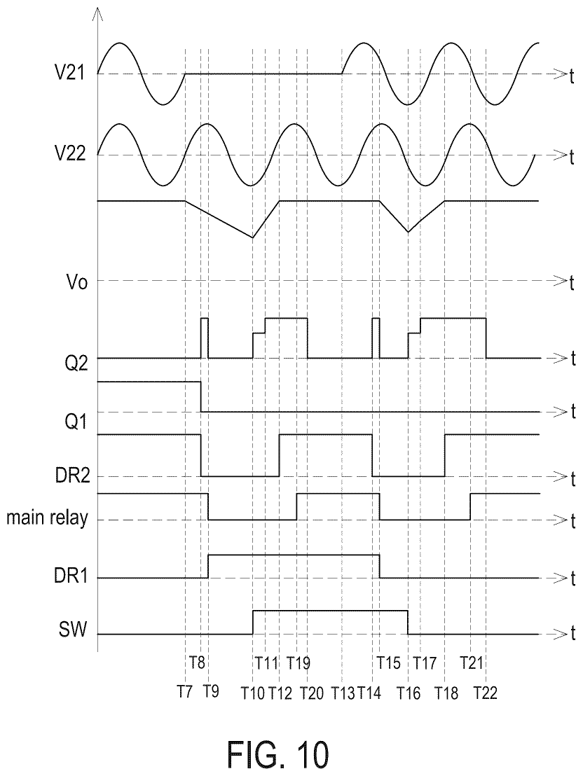

Under the circumstance that during operation, the power supply control device 1a switches from the first power source 21 to the second power source 22 due to the failure of first power source 21 and then switches back to the first power source 21 as the first power source 21 recovers, the corresponding operating waveforms are schematically shown in FIG. 10. In FIG. 10, the waveforms and operation before time T13 are similar with that shown in FIG. 9, and thus detailed descriptions thereof are omitted herein. After time T13 and upon confirming that the first power source 21 has recovered, at time T14, the control unit 17 outputs the control signal DR2 for controlling the main relay 18 to turn off. To avoid arcing while turning off the main relay 18, the control unit 17 also controls the second transistor Q2 to be in the fully conductive state. After a delay, at time T15, the main relay 18 turns off, and the control unit 17 controls the second transistor Q2 to turn off and outputs the control signal DR1 for control the input switching unit 13 to switch to connect to the first input terminal 11. Then, at time T18, the output voltage Vo reaches the reference value, and the control unit 17 outputs the control signal DR2 for controlling the main relay 18 to turn on. Afterwards, at time T21, the main relay 18 turns on. Then, at time T22, the control unit 17 controls the second transistor Q2 to turn off.

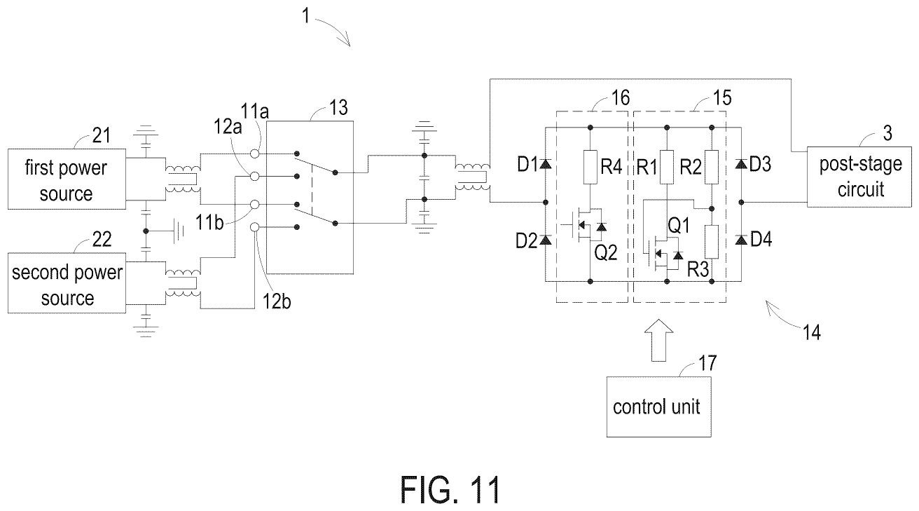

Additionally, the input switching unit 13 includes a first output terminal and a second output terminal, and the post-stage circuit 3 includes a first input terminal and a second input terminal. In the above embodiments, the current limiting module (14, 14a) is electrically connected in series between the first output terminal of the input switching unit 13 and the first input terminal of the post-stage circuit 3. However, the present disclosure is not limited thereto. In another embodiment, the current limiting module (14, 14a) may be electrically connected in series between the second output terminal of the input switching unit 13 and the second input terminal of the post-stage circuit 3, as exemplified in FIG. 11.

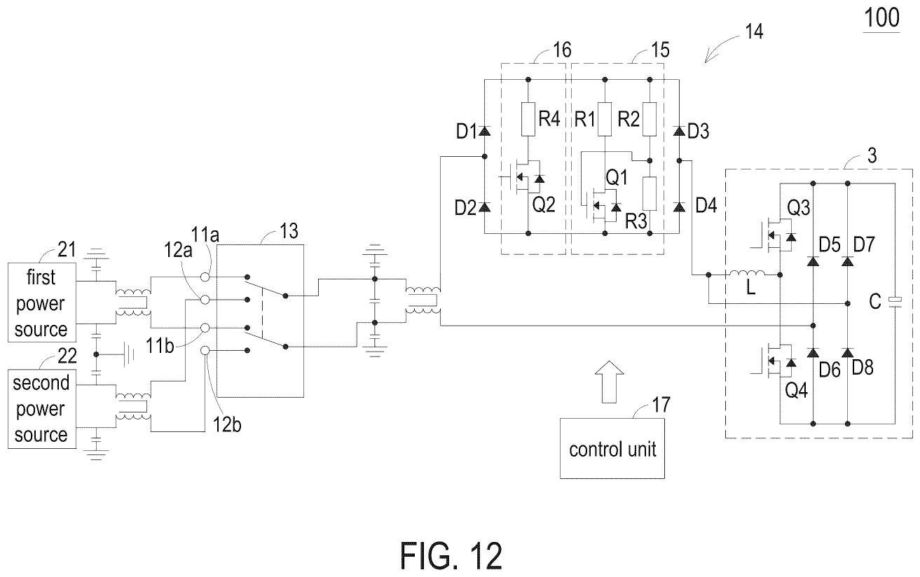

FIG. 12 is a schematic circuit diagram illustrating a power supply device according to an embodiment of the present disclosure. In FIG. 12, the component parts and elements corresponding to those of FIG. 2 are designated by identical numeral references, and detailed descriptions thereof are omitted herein. As shown in FIG. 12, in this embodiment, the post-stage circuit 3 of the power supply device 100 includes a power factor correction circuit and an output capacitor C. The power factor correction circuit includes an inductor L, a switch bridge arm and a diode bridge arm. The switch bridge arm and the diode bridge arm are electrically connected in parallel to the output capacitor C. The switch bridge arm includes a third transistor Q3 and a fourth transistor Q4 electrically connected in series. The diode bridge arm includes a fifth diode D5 and a sixth diode D6 electrically connected in series. The first and second terminals of the inductor L are electrically connected to the current limiting module 14 and a common connection point of the third transistor Q3 and fourth transistor Q4 respectively. The power factor correction circuit further includes a bypass branch which includes a diode bridge arm electrically connected in parallel to the output capacitor C. The diode bridge arm includes a seventh diode D7 and an eighth diode D8, and a common connection point of the seventh diode D7 and the eighth diode D8 is electrically connected to the first terminal of the inductor L. During the startup or switching stage, the input current charges the output capacitor C through the seventh diode D7 and the eighth diode D8.

It is noted that FIG. 12 only exemplify one implementation of the post-stage circuit, but the possible implementation of the post-stage circuit in the present disclosure is not limited thereto.

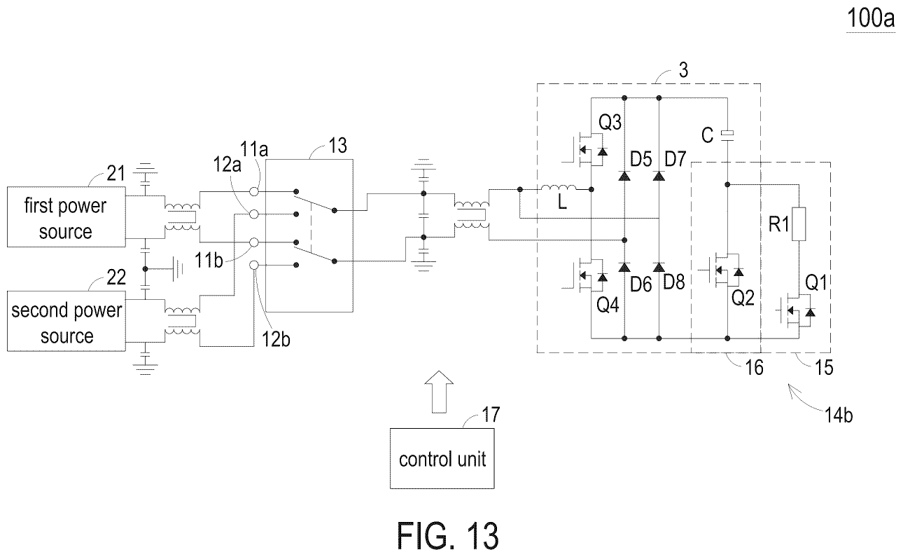

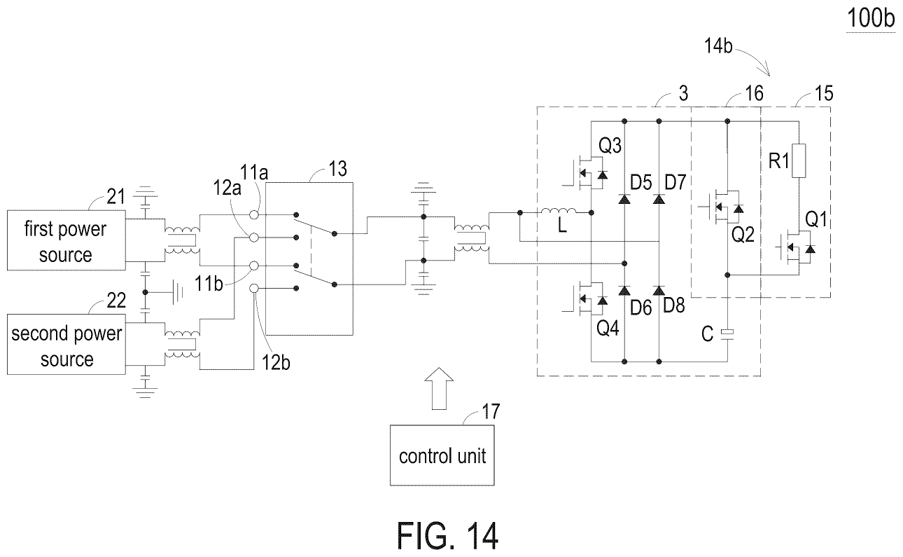

Moreover, in the above embodiments, the current limiting module (14, 14a) is connected between the input switching unit 13 and the post-stage circuit 3. However, the present disclosure is not limited thereto. In an embodiment, in a case that the post-stage circuit 3 includes the power factor correction circuit and the output capacitor C, the current limiting module may be connected between the power factor correction circuit and the output capacitor C. Further, in this case, there is no need to additionally dispose a rectifier circuit connected to the current limiting module 14b. In an embodiment, as shown in FIG. 13, in the power supply device 100a, the power factor correction circuit further includes a first output terminal and a second output terminal, the current limiting module 14b is connected between the second output terminal of the power factor correction circuit and a negative terminal of the output capacitor C. In another embodiments, as shown in FIG. 14, in the power supply device 100b, the current limiting module 14b may be connected between the first output terminal of the power factor correction circuit and a positive terminal of the output capacitor C. When adopting the connection manner shown in FIG. 13 or FIG. 14, the post-stage load, such as an LLC circuit, may be electrically connected to the first and second output terminals of the power factor correction circuit to obtain power, or may be directly electrically connected to the positive and negative terminals of the output capacitor C to obtain power. Furthermore, in the embodiments shown in FIG. 13 and FIG. 14, the operations of the input switching unit 13, the first current limiting unit 15, and the second current limiting unit 16 are the same as that shown in FIG. 3 to FIG. 6, and detailed descriptions thereof are omitted herein. It should be understood that the current limiting modules in FIG. 13 and FIG. 14 may also include the first and second divider resistors for driving the first transistor Q1.

In addition, in the above embodiments, the power supply device and the power supply control device are both connected to two power sources (i.e., the first power source 21 and the second power source 22), and one of the two power sources is selected as the supply power source for supplying power to the post-stage circuit through switching. However, actually, the present disclosure is not limited thereto. In specific, each of the power supply device and the power supply control device of the present disclosure may be connected to only one power source which serves as the supply power source for supplying power to the post-stage circuit. In other words, the power supply device and the power supply control device in the above embodiments may be connected to only one power source, and in such a case, the input switching unit may be omitted.

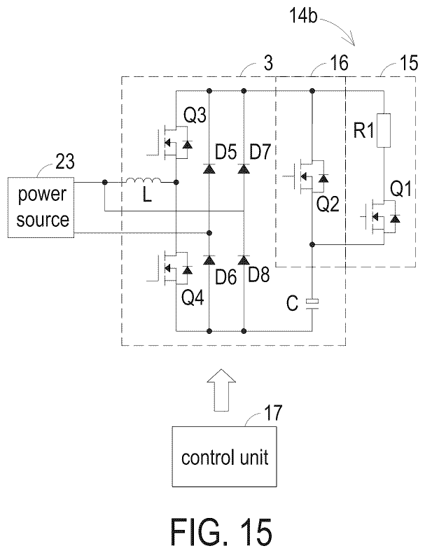

Taking the power supply device 100b shown in FIG. 14 as an example, FIG. 15 exemplifies a variant of the power supply device of FIG. 14. In FIG. 15, the component parts and elements corresponding to those of FIG. 14 are designated by identical numeral references, and detailed descriptions thereof are omitted herein. As shown in FIG. 15, in this embodiment, the power supply device 100c is connected to only one power source 23 and does not include an input switching unit. The disposing position of the current limiting module 14b is not limited to that shown in FIG. 15 and may be adjusted according to the disposing positions shown in FIG. 11 to FIG. 14, and detailed descriptions thereof are omitted herein. The corresponding operation process is described as follows.

Under the circumstance that the post-stage circuit 3 starts up when the power source 23 is normal, the specific operation and waveform changes are the same as that shown in FIG. 3, and thus detailed descriptions thereof are omitted herein.

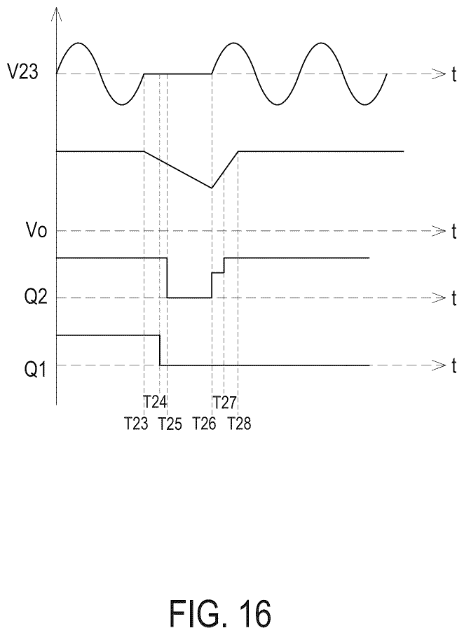

If the power source 23 fails during operation, the post-stage circuit 3 cannot continue to operate. However, if the power source 23 recovers shortly after a brief failure, the corresponding operating waveforms are schematically shown in FIG. 16. In FIG. 16, V23 represents the power provided by the power source 23. Please refer to FIG. 16 in conjunction with FIG. 15. Before time T23, the power source 23 serves as the supply power source and provides power normally. At time T23, the power source 23 fails and stops providing power, and the output voltage Vo begins to decrease gradually. After a certain delay (to avoid false operation), at time T24, the control unit 17 controls the first transistor Q1 to turn off. It should be understood that turning off the first transistor Q1 at time T24 is just an example, and actually the first transistor Q1 only needs to turn off before time T25 (i.e., before the control unit 17 controls the second transistor Q2 to turn off). At time T25, the control unit 17 controls the second transistor Q2 to turn off. After a first time period, at time T26, the power source 23 recovers and begins to supply power. It should be understood that the first time period is a short time interval that does not exceed the maximum waiting time specified by the power system. If the power outage exceeds the maximum waiting time, the power supply device stops operating. Further, at time T26, the control unit 17 controls the second transistor Q2 to turn on, thereby allowing the output voltage Vo to increase. The control for the second transistor Q2 depends on a difference between an absolute value of the input voltage Vin and the output voltage Vo such that the inrush current is limited. In specific, at time T26, the difference between the absolute value of the input voltage Vin and the output voltage Vo is greater than the second threshold value, thus the control unit 17 controls the second transistor Q2 to operate in the linear region and regulates the drive voltage of the second transistor Q2 to limit the current flowing through the second transistor Q2 to the preset current. Under this circumstance, the second current limiting unit 16 is in the current limiting state. At time T27, the difference between the absolute value of the input voltage Vin and the output voltage Vo begins to be less than or equal to the second threshold value, thus the control unit 17 controls the second transistor Q2 to operate in the saturation region, and afterwards the second current limiting unit 16 is in the fully conductive state. After the second transistor Q2 operates in the saturation region, at time T28, the output voltage Vo reaches the reference value.

In addition, if the circuit structure in any of the above embodiments is modified to connect to only one power source and exclude an input switching unit, the corresponding operation process is also similar, and thus detailed descriptions thereof are omitted herein.

In summary, the present disclosure provides a power supply device, a power supply control device and a control method thereof which can limit the inrush current generated during startup to realize soft start. Further, the power supply device, the power supply control device and the control method thereof of the present disclosure also can limit the inrush current generated during the fluctuation of the received power source (e.g., the power source recovers after a brief fault or the supply power source switches between plural power sources).

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply control device, electrically connected to a power source, wherein the power source is configured to provide power to a post-stage circuit of the power supply control device, and the power supply control device comprises:
a current limiting module, electrically connected to the power source and the post-stage circuit, and comprising a first current limiting unit and a second current limiting unit electrically connected in parallel, wherein the first current limiting unit is configured to limit an inrush current generated during startup of the post-stage circuit, and the second current limiting unit is configured to limit an inrush current generated during a fluctuation of the power source; and
a control unit, electrically connected to the current limiting module, and configured to control the first current limiting unit and the second current limiting unit.

2. The power supply control device according to claim 1, wherein when the post-stage circuit starts up, the first current limiting unit is turned on, and the control unit is configured to control the second current limiting unit to turn on if a difference between a maximum value of an input voltage received by the power supply control device and an output voltage of the post-stage circuit is less than a first threshold value.

3. The power supply control device according to claim 1, wherein the fluctuation of the power source is that the power source fails and then recovers after a first time period; when the power source fails and then recovers after the first time period, the control unit is configured to control the second current limiting unit to operate in a current limiting state or a fully conductive state according to a comparison between an absolute value of an input voltage received by the power supply control device and an output voltage of the post-stage circuit.

4. The power supply control device according to claim 3, wherein when the power source fails and then recovers after the first time period, the control unit is configured to control the second current limiting unit to be in the current limiting state to limit a current flowing through the second current limiting unit to a preset current if a difference between the absolute value of the input voltage and the output voltage is greater than a second threshold value, and the control unit is configured to control the second current limiting unit to be in the fully conductive state if the difference is less than or equal to the second threshold value.

5. The power supply control device according to claim 1, wherein the power source comprises a first power source and a second power source, the power supply control device further comprises a first input terminal, a second input terminal and an input switching unit, the first input terminal is electrically connected to the first power source, the second input terminal is electrically connected to the second power source, the input switching unit is configured to switch between connecting to the first input terminal and connecting to the second input terminal so that one of the first power source and the second power source serves as a supply power source which supplies power to the post-stage circuit, and the fluctuation of the power source is switching between the first power source and the second power source; the current limiting module is electrically connected to the input switching unit, and the second current limiting unit is further configured to limit an inrush current generated during switching of the input switching unit; the control unit is further electrically connected to the input switching unit and is configured to control the input switching unit.

6. The power supply control device according to claim 5, wherein when the post-stage circuit starts up, the first current limiting unit is turned on, and the control unit is configured to control the second current limiting unit to turn on if a difference between a maximum value of an input voltage received by the power supply control device and an output voltage of the post-stage circuit is less than a first threshold value.

7. The power supply control device according to claim 5, wherein the current limiting module further comprises a main relay electrically connected in parallel to the first current limiting unit and the second current limiting unit; when the supply power source fails, the control unit is configured to output a control signal for controlling the main relay to turn off, to control the first current limiting unit to turn off, and to control the second current limiting unit to be in a fully conductive state, and the control unit is configured to control the second current limiting unit to turn off after the main relay turns off.

8. The power supply control device according to claim 5, wherein when the input switching unit switches from connecting to one of the first input terminal and the second input terminal to connecting to another one of the first input terminal and the second input terminal, the control unit is configured to control the second current limiting unit to be in the current limiting state to limit a current flowing through the second current limiting unit to a preset current if a difference between an absolute value of the input voltage and the output voltage is greater than a second threshold value, and the control unit is configured to control the second current limiting unit to be in the fully conductive state if the difference is less than or equal to the second threshold value.

9. The power supply control device according to claim 8, wherein the current limiting module further comprises a main relay electrically connected in parallel to the first current limiting unit and the second current limiting unit; when the input switching unit switches from connecting to one of the first input terminal and the second input terminal to connecting to another one of the first input terminal and the second input terminal, if the difference is less than or equal to the second threshold value, the control unit is configured to control the main relay to turn on after the second current limiting unit is in the fully conductive state.

10. The power supply control device according to claim 5, wherein the first current limiting unit comprises a current limiting resistor and a first transistor electrically connected in series between a first node and a second node; when the post-stage circuit starts up, the first transistor turns on so that a current flowing into the post-stage circuit is limited by the current limiting resistor; wherein the first transistor is configured to be turned on based on a difference between an input voltage received by the power supply control device and an output voltage of the post-stage circuit.

11. The power supply control device according to claim 10, wherein the first current limiting unit further comprises a first divider resistor and a second divider resistor, a first terminal and a second terminal of the first divider resistor are electrically connected to the first node and a control terminal of the first transistor respectively, and a first terminal and a second terminal of the second divider resistor are electrically connected to the control terminal of the first transistor and the second node respectively.

12. The power supply control device according to claim 5, wherein the second current limiting unit comprises a second transistor; when the input switching unit switches from connecting to one of the first input terminal and the second input terminal to connecting to another one of the first input terminal and the second input terminal, the control unit is configured to control the second transistor to operate in a linear region to limit a current flowing through the second transistor to a preset current if a difference between an absolute value of an input voltage received by the power supply control device and an output voltage of the post-stage circuit is greater than a second threshold value, and the control unit is configured to control the second transistor to operate in a saturation region if the difference is less than or equal to the second threshold value.

13. The power supply control device according to claim 5, wherein the current limiting module is electrically connected in series between the input switching unit and the post-stage circuit.

14. The power supply control device according to claim 13, further comprising a rectifier circuit configured to rectify a current flowing into the first current limiting unit and the second current limiting unit into a DC current; wherein the rectifier circuit comprises a first rectifier bridge arm and a second rectifier bridge arm electrically connected in parallel to the first current limiting unit and the second current limiting unit, the first rectifier bridge arm comprises a first diode and a second diode, the second rectifier bridge arm comprises a third diode and a fourth diode, a common connection point of the first diode and the second diode is connected to the input switching unit, and a common connection point of the third diode and the fourth diode is connected to the post-stage circuit.

15. The power supply control device according to claim 1, wherein the post-stage circuit comprises a power factor correction circuit and a capacitor, and the current limiting module is electrically connected in series between an output terminal of the power factor correction circuit and the capacitor.

16. A control method of a power supply control device, wherein the power supply control device is electrically connected to a power source, the power source is configured to provide power to a post-stage circuit of the power supply control device, the power supply control device comprises a current limiting module electrically connected to the power source and the post-stage circuit, the current limiting module comprises a first current limiting unit and a second current limiting unit electrically connected in parallel, and the control method comprises:
controlling the first current limiting unit to limit an inrush current generated during startup of the post-stage circuit; and
controlling the second current limiting unit to limit an inrush current generated during a fluctuation of the power source.

17. The control method according to claim 16, further comprising: when the post-stage circuit starts up, controlling the second current limiting unit to turn on if a difference between a maximum value of an input voltage received by the power supply control device and an output voltage of the post-stage circuit is less than a first threshold value.

18. The control method according to claim 16, wherein the fluctuation of the power source is that the power source fails and then recovers after a first time period, and the control method further comprises:
when the power source fails and then recovers after the first time period,
if a difference between an absolute value of the input voltage and the output voltage is greater than a second threshold value, controlling the second current limiting unit to be in the current limiting state to limit a current flowing through the second current limiting unit to a preset current; and
if the difference is less than or equal to the second threshold value, controlling the second current limiting unit to be in the fully conductive state.

19. The control method according to claim 16, wherein the power source comprises a first power source and a second power source, the power supply control device further comprises a first input terminal, a second input terminal and an input switching unit, the first input terminal is electrically connected to the first power source, the second input terminal is electrically connected to the second power source, and the control method further comprises:
controlling the input switching unit to switch between connecting to the first input terminal and connecting to the second input terminal so that one of the first power source and the second power source serves as a supply power source which supplies power to the post-stage circuit, wherein the fluctuation of the power source is switching between the first power source and the second power source; and
controlling the second current limiting unit to limit an inrush current generated during switching of the input switching unit.

20. The control method according to claim 19, wherein the current limiting module further comprises a main relay electrically connected in parallel to the first current limiting unit and the second current limiting unit, and the control method further comprises:
when the supply power source fails, outputting a control signal for controlling the main relay to turn off, controlling the first current limiting unit to turn off, controlling the second current limiting unit to be in a fully conductive state, and controlling the second current limiting unit to turn off after the main relay turns off.

21. The control method according to claim 19, wherein when the input switching unit switches from connecting to one of the first input terminal and the second input terminal to connecting to another one of the first input terminal and the second input terminal, the control method further comprises:
if a difference between an absolute value of the input voltage and the output voltage is greater than a second threshold value, controlling the second current limiting unit to be in the current limiting state to limit a current flowing through the second current limiting unit to a preset current; and
if the difference is less than or equal to the second threshold value, controlling the second current limiting unit to be in the fully conductive state.

22. The control method according to claim 21, wherein the current limiting module further comprises a main relay electrically connected in parallel to the first current limiting unit and the second current limiting unit; when the input switching unit switches from connecting to one of the first input terminal and the second input terminal to connecting to another one of the first input terminal and the second input terminal, the control method further comprises:
if the difference is less than or equal to the second threshold value, controlling the main relay to turn on after the second current limiting unit is in the fully conductive state.

23. The control method according to claim 19, wherein the first current limiting unit comprises a current limiting resistor and a first transistor electrically connected in series between a first node and a second node, and the control method further comprises:
when the post-stage circuit starts up, turning on the first transistor by a difference between an input voltage received by the power supply control device and an output voltage of the post-stage circuit, so that a current flowing into the post-stage circuit is limited by the current limiting resistor.

24. The control method according to claim 19, wherein the second current limiting unit comprises a second transistor, and the control method further comprises:
when the input switching unit switches from connecting to one of the first input terminal and the second input terminal to connecting to another one of the first input terminal and the second input terminal, controlling the second transistor to operate in a linear region to limit a current flowing through the second transistor to a preset current if a difference between an absolute value of an input voltage received by the power supply control device and an output voltage of the post-stage circuit is greater than a second threshold value, and controlling the second transistor to operate in a saturation region if the difference is less than or equal to the second threshold value.

25. A power supply device, electrically connected to a power source, and comprising:
a post-stage circuit, comprising a power factor correction circuit and a capacitor electrically connected in parallel, wherein the post-stage circuit is powered by the power source;
a current limiting module, electrically connected between the power source and the post-stage circuit or between the power factor correction circuit and the capacitor, and comprising a first current limiting unit and a second current limiting unit electrically connected in parallel, wherein the first current limiting unit is configured to limit an inrush current generated during startup of the post-stage circuit, and the second current limiting unit is configured to limit an inrush current generated during a fluctuation of the power source; and
a control unit, electrically connected to the current limiting module, and configured to control the first current limiting unit and the second current limiting unit.

26. The power supply device according to claim 25, wherein the power source comprises a first power source and a second power source, the power supply device further comprises a first input terminal, a second input terminal and an input switching unit, the first input terminal is electrically connected to the first power source, the second input terminal is electrically connected to the second power source, the input switching unit is configured to switch between connecting to the first input terminal and connecting to the second input terminal so that one of the first power source and the second power source serves as a supply power source which supplies power to the post-stage circuit, and the fluctuation of the power source is switching between the first power source and the second power source; the current limiting module is electrically connected to the input switching unit, and the second current limiting unit is further configured to limit an inrush current generated during switching of the input switching unit; the control unit is further electrically connected to the input switching unit and is configured to control the input switching unit.
